(19) United States
(12) Patent Application Publication
(10) Pub. No.: US 2013/0162694 A1
(43) Pub. Date: Jun. 27, 2013

(54) LIGHT SOURCE DEVICE, DISPLAY UNIT, AND ELECTRONIC APPARATUS

(71) Applicant: Sony Corporation, Tokyo (JP)

(72) Inventors: Mamoru Suzuki, Tokyo (JP); Hiromasa Suzuki, Kanagawa (JP)

(73) Assignee: Sony Corporation, Tokyo (JP)

(21) Appl. No.: 13/670,544

(22) Filed: Nov. 7, 2012

(30) Foreign Application Priority Data
Nov. 14, 2011 (JP) 2011-248474

(51) Int. Cl. F21V 8/00; G09G 5/10

(52) U.S. Cl. CPC G02B 6/0043; G09G 5/10
USPC 345/690; 362/608

(57) ABSTRACT

A display unit includes: a display section displaying an image; and a light source device emitting light for image display toward the display section, the light source device including a first light source emitting first illumination light and a light guide plate, the light guide plate including a plurality of scattering regions that allow the first illumination light entering through a side surface of the light guide plate to be scattered and then to exit from the light guide plate, in which the scattering regions each are configured of a plurality of scattering patterns including a first scattering pattern with a width varying according to a distance from the first light source.

### BACKGROUND

The present disclosure relates to a light source device and a display unit capable of achieving stereoscopic vision by a parallax barrier system, and an electronic apparatus.

As one of stereoscopic display systems capable of achieving stereoscopic vision with naked eyes without wearing special glasses, a parallax barrier system stereoscopic display unit is known. In the stereoscopic display unit, a parallax barrier is disposed to face a front side (a display plane side) of a two-dimensional display panel. In a typical configuration of the parallax barrier, shielding sections shielding display image light from the two-dimensional display panel and stripe-shaped opening sections (slit sections) allowing the display image light to pass therethrough are alternately arranged in a horizontal direction.

In the parallax barrier system, parallax images for stereoscopic vision (a right-eye perspective image and a left-eye perspective image in the case of two perspectives) which are spatially separated from one another are displayed on a two-dimensional display panel, and the parallax images are separated by parallax in a horizontal direction by a parallax barrier to achieve stereoscopic vision. When a slit width or the like in the parallax barrier is appropriately determined, in the case where a viewer watches the stereoscopic display unit from a predetermined position and a predetermined direction, light rays from different parallax images enter respective right and left eyes of the viewer through the slit sections.

It is to be noted that, in the case where, for example, a transmissive liquid crystal display panel is used as the two-dimensional display panel, a parallax barrier may be disposed behind the two-dimensional display panel (refer to FIG. 10 in Japanese Patent No. 3565391 and FIG. 3 in Japanese Unexamined Patent Application Publication No. 2007-187823). In this case, the parallax barrier is disposed between the transmissive liquid crystal display panel and a backlight.

### SUMMARY

In parallax barrier system stereoscopic display units, a component exclusive for three-dimensional display, i.e., a parallax barrier is necessary; therefore, more components and a larger space for the components are necessary, compared to a typical display unit for two-dimensional display.

It is desirable to provide a light source device and a display unit capable of achieving a function equivalent to a parallax barrier with use of a light guide plate and obtaining illumination light with a desired luminance distribution, and an electronic apparatus.

According to an embodiment of the disclosure, there is provided a light source device including: a first light source emitting first illumination light; and a light guide plate including a plurality of scattering regions that allow the first illumination light entering through a side surface of the light guide plate to be scattered and then to exit from the light guide plate, in which the scattering regions each are configured of a plurality of scattering patterns including a first scattering pattern with a width varying according to a distance from the first light source.

According to an embodiment of the disclosure, there is provided a display unit including: a display section displaying an image; and a light source device emitting light for image display toward the display section, the light source device including a first light source emitting first illumination light and a light guide plate, the light guide plate including a plurality of scattering regions that allow the first illumination light entering through a side surface of the light guide plate to be scattered and then to exit from the light guide plate, in which the scattering regions each are configured of a plurality of scattering patterns including a first scattering pattern with a width varying according to a distance from the first light source.

According to an embodiment of the disclosure, there is provided an electronic apparatus including a display unit, the display unit including: a display section displaying an image; and a light source device emitting light for image display toward the display section, the light source device including a first light source emitting first illumination light and a light guide plate, the light guide plate including a plurality of scattering regions that allow the first illumination light entering through a side surface of the light guide plate to be scattered and then to exit from the light guide plate, in which the scattering regions each are configured of a plurality of scattering patterns including a first scattering pattern with a width varying according to a distance from the first light source.

In the light source device, the display unit, and the electronic apparatus according to the embodiments of the disclosure, the first illumination light from the first light source is scattered by the scattering regions to exit from the light guide plate. Therefore, the light guide plate has a function as a parallax barrier for the first illumination light. In other words, the light guide plate equivalently functions as a parallax barrier with the scattering regions as opening sections (slit sections). Therefore, three-dimensional display is possible. Moreover, the scattering regions each are configured of a plurality of scattering patterns, and each include a first scattering pattern with a width varying according to the distance from the first light source; therefore, illumination light with a desired luminance distribution is obtained.

In the light source device, the display unit, and the electronic apparatus according to the embodiments of the disclosure, the light guide plate has the plurality of scattering regions allowing the first illumination light to be scattered; therefore, the light guide plate equivalently has a function as a parallax barrier for the first illumination light. Moreover, the scattering regions each are configured of a plurality of scattering patterns and each include the first scattering pattern with a width varying according to the distance from the first light source; therefore, illumination light with a desired luminance distribution is obtainable.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the technology, and are incorporated in and constitute a part of this specification. The drawings illustrate embodiments and, together with the specification, serve to explain the principles of the technology.

FIG. 1 is a sectional view illustrating a configuration example of a display unit according to a first embodiment of the disclosure with a state of emission of light rays from a light source device in the case where only a first light source is maintained in an ON (turned-on) state.

FIG. 2 is a sectional view illustrating a configuration example of the display unit illustrated in FIG. 1 with a state of emission of light rays from the light source device in the case where only a second light source is maintained in an ON (turned-on) state.

FIG. 3 is a plan view illustrating an example of a pixel configuration of a display section.

FIG. 4 is an explanatory diagram illustrating a luminance distribution in a Y direction and in an X direction in a display unit according to a first comparative example in the case where first light sources are disposed to face a first side surface and a second side surface in the Y direction of a light guide plate.

FIG. 5 is an explanatory diagram illustrating a luminance distribution in the Y direction and in the X direction in a display unit according to a second comparative example in the case where first light sources are disposed to face a third side surface and a fourth side surface in the X direction of a light guide plate.

FIG. 6 is an explanatory diagram illustrating a luminance distribution in the Y direction and in the X direction in a display unit according to a third comparative example in the case where first light sources are disposed to face a first side surface and a second side surface in the Y direction of a light guide plate.

FIG. 7 is a plan view and an explanatory diagram, where a part (A) illustrates a plan view of the light guide plate in the display unit according to the third comparative example and a part (B) illustrates an explanatory diagram illustrating light-distribution characteristics in the display unit according to the third comparative example.

FIG. 8 is a sectional view illustrating a basic configuration of a scattering region.

FIG. 9 is a plan view illustrating the basic configuration of the scattering region.

FIG. 10 is a sectional view illustrating a first specific configuration example of the scattering region.

FIG. 11 is a sectional view illustrating a second specific configuration example of the scattering region.

FIG. 12 is a sectional view illustrating a third specific configuration example of the scattering region.

FIG. 13 is an explanatory diagram illustrating a first modification of the configuration of the scattering region.

FIG. 14 is an explanatory diagram illustrating a second modification of the configuration of the scattering region.

FIG. 15 is a sectional view illustrating a basic configuration of a scattering region in a display unit according to a second embodiment.

FIG. 16A-B are plan views illustrating the basic configuration of the scattering region in the display unit according to the second embodiment.

FIG. 17 is a sectional view illustrating a first specific configuration example of the scattering region in the display unit according to the second embodiment.

FIG. 18 is a sectional view illustrating a second specific configuration example of the scattering region in the display unit according to the second embodiment.

FIG. 19 is a sectional view illustrating a third specific configuration example of the scattering region in the display unit according to the second embodiment.

FIGS. 20A and 20B are sectional views illustrating a configuration example of a display unit according to a third embodiment with states of emission of light rays from a light source device in three-dimensional display and in two-dimensional display, respectively.

FIGS. 21A and 21B are sectional views illustrating a configuration example of a display unit according to a fourth embodiment with states of emission of light rays from a light source device in three-dimensional display and in two-dimensional display, respectively.

FIGS. 22A and 22B are sectional views illustrating a configuration example of a display unit according to a fifth embodiment with states of emission of light rays from a light source device in three-dimensional display and in two-dimensional display, respectively.

FIG. 30 is an appearance diagram illustrating an example of an electronic apparatus.

### DETAILED DESCRIPTION

Preferred embodiments of the disclosure will be described in detail below referring to the accompanying drawings. It is to be noted that description will be given in the following order.

1. First Embodiment

An example of a display unit using a first light source and a second light source

An example in which scattering regions each are configured of a plurality of scattering patterns

2. Second Embodiment

Modifications of the configuration of the scattering region

3. Third Embodiment

An example of a display unit in which scattering regions are located on a first internal reflection plane

4. Fourth Embodiment

An example of a display unit using a first light source and an electronic paper

5. Fifth Embodiment

An example of a display unit using a first light source and a polymer diffuser plate

6. Other Embodiments

A configuration example of an electronic apparatus, and the like

### 1. First Embodiment

### [Entire Configuration of Display Unit]

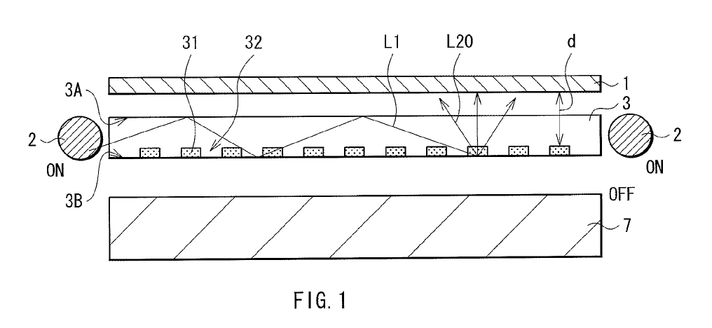

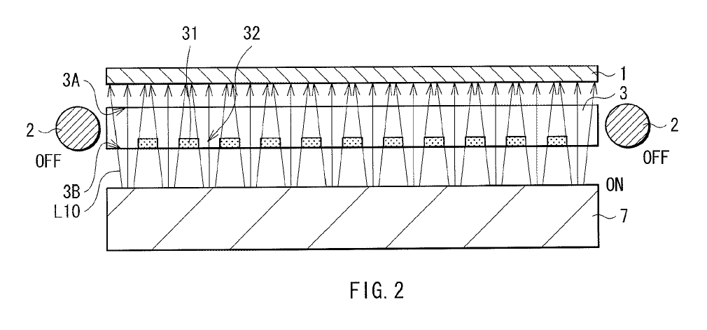

FIGS. 1 and 2 illustrate a configuration example of a display unit according to a first embodiment of the disclosure. The display unit includes a display section 1 which displays an image and a light source device which is disposed on a back side of the display section 1 and emits light for image display toward the display section 1. The light source device includes a first light source 2 (a 2D/3D-display light source), a light guide plate 3, and a second light source 7 (a 2D-display light source). The light guide plate 3 has a first internal reflection plane 3A facing the display section 1 and a second internal reflection plane 3B facing the second light source 7. It is to be noted that the display unit further includes a control circuit for the display section 1 or the like which is necessary for display; however, the control circuit or the like has a configuration similar to that of a typical control circuit for display or the like, and will not be described here. Moreover, the light source device includes a control circuit (not illustrated) controls ON (turned-on) and OFF (turned-off) states of the first light source 2 and the second light source 7.

It is to be noted that, in the embodiment, a first direction (a vertical direction) in a display plane (a plane where pixels are arranged) of the display section 1 or a plane parallel to the second internal reflection plane 3B of the light guide plate 3 is referred to as a Y direction, and a second direction (a horizontal direction) orthogonal to the first direction is referred to as an X direction.

The display unit is capable of arbitrarily and selectively performing switching between a two-dimensional display mode on an entire screen and a three-dimensional display mode on the entire screen. Switching between the two-dimensional display mode and the three-dimensional display mode is performed by switching control of image data which is to be displayed on the display section 1 and ON/OFF switching control of the first light source 2 and the second light source 7. FIG. 1 schematically illustrates a state of emission of light rays from the light source device in the case where only the first light source 2 is maintained in an ON (turned-on) state, and corresponds to the three-dimensional display mode. FIG. 2 schematically illustrates a state of emission of light rays from the light source device in the case where only the second light source 7 is maintained in an ON (turned-on) state, and corresponds to the two-dimensional display mode.

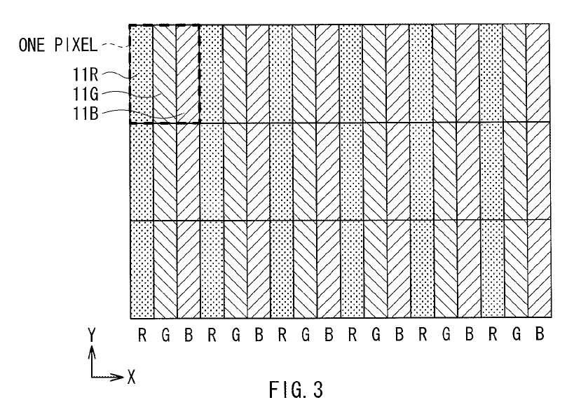

The display section 1 is configured with use of a transmissive two-dimensional display panel, for example, a transmissive liquid crystal display panel, and includes a plurality of pixels configured of, for example, R (red) pixels 11R, G (green) pixels 11G, and B (blue) pixels 11B, and the plurality of pixels are arranged in a matrix form as illustrated in FIG. 3. The display section 1 displays a two-dimensional image through modulating light of each color from the light source device from one pixel to another based on image data. The display section 1 arbitrarily and selectively switches images to be displayed between a plurality of perspective images based on three-dimensional image data and an image based on two-dimensional image data. It is to be noted that the three-dimensional image data is, for example, data including a plurality of perspective images corresponding to a plurality of view angle directions in three-dimensional display. For example, in the case where binocular three-dimensional display is performed, the three-dimensional image data is data including perspective images for right-eye display and left-eye display. In the case where display is performed in the three-dimensional display mode, for example, a composite image including a plurality of stripe-shaped perspective images in one screen is produced and displayed.

The first light source 2 is configured with use of, for example, a fluorescent lamp such as a CCFL (Cold Cathode Fluorescent Lamp), or an LED (Light Emitting Diode). The first light source 2 emits first illumination light L1 (refer to FIG. 1) from a side surface of the light guide plate 3 into an interior thereof. One or more first light sources 2 are disposed on one or more side surfaces of the light guide plate 3. For example, in the case where the light guide plate 3 has a rectangular planar shape, the light guide plate 3 has four side surfaces, and it is only necessary to arrange one or more first light sources 2 on one or more of the four side surfaces. FIG. 1 illustrates a configuration example in which the first light source 2 is disposed on each of two side surfaces facing each other of the light guide plate 3. The first light source 2 is ON (turned-on)/OFF (not turned-on) controlled in response to switching between the two-dimensional display mode and the three-dimensional display mode. More specifically, in the case where the display section 1 displays an image based on the three-dimensional image data (in the case of the three-dimensional display mode), the first light source 2 is controlled to be turned on, and in the case where the display section 1 displays an image based on the two-dimensional image data (in the case of the two-dimensional display mode), the first light source 2 is controlled to be either turned off or turned off.

The second light source 7 is disposed to face the light guide plate 3 on a side where the second internal reflection plane 3B is formed. The second light source 7 emits second illumination light L10 toward the light guide plate 3 from a direction different from the direction where the first light source 2 emits light. More specifically, the second light source 7 emits the second illumination light L10 from an external side (the back side of the light guide plate 3) toward the second internal reflection plane 3B (refer to FIG. 2). The second light source 7 may be a planar light source emitting light with uniform in-plane luminance, and the configuration thereof is not specifically limited, and the second light source 7 may be configured with use of a commercially available planar backlight. For example, a configuration using a light-emitting body such as a CCFL or an LED and a light-scattering plate for equalizing in-plane luminance, or the like is considered. The second light source 7 is ON (turned-on)/OFF (turned-off) controlled in response to switching between the two-dimensional display mode and the three-dimensional display mode. More specifically, in the case where the display section 1 displays an image based on the three-dimensional image data (in the case of the three-dimensional display mode), the second light source 7 is controlled to be turned off, and in the case where the display section 1 displays an image based on the two-dimensional image data (in the case of the two-dimensional display mode), the second light source 7 is controlled to be turned on.

The light guide plate 3 is configured of a transparent plastic plate of, for example, an acrylic resin. All surfaces except for the second internal reflection plane 3B of the light guide plate 3 are entirely transparent. For example, in the case where the light guide plate 3 has a rectangular planar shape, the first internal reflection plane 3A and four side surfaces are entirely transparent.

The entire first internal reflection plane 3A is mirror-finished, and allows light rays incident at an incident angle satisfying a total-reflection condition to be reflected, in a manner of total-internal-reflection, in the interior of the light guide plate 3 and allows light rays out of the total-reflection condition to exit therefrom.

The second internal reflection plane 3B has scattering regions 31 and a total-reflection region 32. As will be described later, light-scattering characteristics are added to the scattering regions 31 through performing laser processing, sandblast processing, or the like on a surface of the light guide plate 3. On the second internal reflection plane 3B, in the three-dimensional display mode, the scattering regions 31 and the total-reflection region 32 function as opening sections (slit sections) and a shielding section, respectively, of a parallax barrier for the first illumination light L1 from the first light source 2. On the second internal reflection plane 3B, the scattering regions 31 and the total-reflection region 32 are arranged in a pattern forming a configuration corresponding to a parallax barrier. In other words, the total-reflection region 32 is arranged in a pattern corresponding to a shielding section in the parallax barrier, and the scattering regions 31 each are arranged in a pattern corresponding to an opening section in the parallax barrier. It is to be noted that, as a barrier pattern of the parallax barrier, for example, various patterns such as a stripe-shaped pattern in which a large number of vertically long slit-like opening sections are arranged side by side in the horizontal direction with shielding sections in between are used, and the barrier pattern of the parallax barrier is not specifically limited.

The first internal reflection plane 3A and the total-reflection region 32 of the second internal reflection plane 3B reflect light rays incident at an incident angle θ1 satisfying a total-reflection condition in a manner of total-internal-reflection (reflect light rays incident at the incident angle θ1 larger than a predetermined critical angle α in a manner of total-internal-reflection). Therefore, the first illumination light L1 incident from the first light source 2 at the incident angle θ1 satisfying the total-reflection condition is guided to a side surface direction by internal total reflection between the first internal reflection plane 3A and the total-reflection region 32 of the second internal reflection plane 3B. Moreover, as illustrated in FIG. 2, the total-reflection region 32 allows the second illumination light L10 from the second light source 7 to pass therethrough and to travel, as a light ray out of the total-reflection condition, toward the first internal reflection plane 3A.

It is to be noted that the critical angle α is represented as follows, where the refractive index of the light guide plate 3 is n1, and the refractive index of a medium (an air layer) outside the light guide plate 3 is n0 (<n1). The angles α and θ1 are angles with respect to a normal to a surface of the light guide plate. The incident angle θ1 satisfying the total-reflection condition is θ1>α.

sin α=n0/n1

As illustrated in FIG. 1, the scattering regions 31 scatter and reflect the first illumination light L1 from the first light source 2 and allow a part or a whole of the first illumination light L1 to travel, as a light ray (a scattering light ray L20) out of the total-reflection condition, toward the first internal reflection plane 3A.

It is to be noted that, in the display unit illustrated in FIG. 1, to spatially separate a plurality of perspective images displayed on the display section 1, it is necessary to dispose a pixel section of the display section 1 and the scattering regions 31 to face each other with a predetermined distance d in between. In FIG. 1, the display section 1 and the light guide plate 3 are disposed with air in between; however, to keep the predetermined distance d between the display section 1 and the light guide plate 3, a spacer may be disposed between the display section 1 and the light guide plate 3. In this case, the spacer may be made of a colorless and transparent material with less scattering, and, for example, PMMA may be used. The spacer may be disposed to cover an entire back surface of the display section 1 and an entire surface of the light guide plate 3, or may be disposed in a minimum region necessary to keep the predetermined distance d. Moreover, an entire thickness of the light guide plate 3 may be increased to remove air between the display section 1 and the light guide plate 3.

### [Basic Operation of Display Unit]

In the case where the display unit performs display in the three-dimensional display mode, the display section 1 displays an image based on the three-dimensional image data, and ON (turned-on)/OFF (turned-off) control of the first light source 2 and the second light source 7 is performed for three-dimensional display. More specifically, as illustrated in FIG. 1, the first light source 2 is controlled to be in the ON (turned-on) state, and the second light source 7 is controlled to be in the OFF (turned-off) state. In this state, the first illumination light L1 from the first light source 2 is reflected repeatedly in a manner of total-internal-reflection between the first internal reflection plane 3A and the total-reflection region 32 of the second internal reflection plane 3B in the light guide plate 3 to be guided from a side surface where the first light source 2 is disposed to the other side surface facing the side surface and then to be emitted from the other side surface. On the other hand, a part of the first illumination light L1 from the first light source 2 is scattered and reflected by the scattering regions 31 of the light guide plate 3 to pass through the first internal reflection plane 3A of the light guide plate 3 and exit from the light guide plate 3. Thus, the light guide plate 3 has a function as a parallax barrier. In other words, for the first illumination light L1 from the first light source 2, the light guide plate 3 equivalently functions as a parallax barrier with the scattering regions 31 as opening sections (slit sections) and the total-reflection region 32 as a shielding section. Therefore, three-dimensional display by a parallax barrier system in which the parallax barrier is disposed on the back side of the display section 1 is equivalently performed.

On the other hand, in the case where display is performed in the two-dimensional display mode, the display section 1 displays an image based on the two-dimensional image data, and ON (turned-on)/OFF (turned-off) control of the first light source 2 and the second light source 7 is performed for two-dimensional display. More specifically, for example, as illustrated in FIG. 2, the first light source 2 is controlled to be in the OFF (turned-off) state, and the second light source 7 is controlled to be in the ON (turned-on) state. In this case, the second illumination light L10 from the second light source 7 passes through the total-reflection region 32 of the second internal reflection plane 3B to exit as a light ray out of the total-reflection condition from substantially the entire first internal reflection plane 3A of the light guide plate 3. In other words, the light guide plate 3 functions as a planar light source similar to a typical backlight. Therefore, two-dimensional display by a backlight system in which a typical backlight is disposed on the back side of the display section 1 is equivalently performed.

It is to be noted that, when only the second light source 7 is turned on, the second illumination light L10 exits from substantially the entire surface of the light guide plate 3; however, if necessary, the first light source 2 may be turned on. For example, in the case where there is a difference in a luminance distribution between portions corresponding to the scattering regions 31 and a portion corresponding to the total-reflection region 32 when only the second light source 7 is turned on, the lighting state of the first light source 2 is appropriately adjusted (ON/OFF control or the lighting amount of the first light source 2 is adjusted) to allow an entire luminance distribution to be optimized. However, for example, in the case where luminance is sufficiently corrected in the display section 1 when two-dimensional display is performed, it is only necessary to turn on the second light source 7 only.

### [Relationship Between Width of Scattering Region 31 and Luminance Distribution]

A relationship between a width of the scattering region 31 and a luminance distribution in three-dimensional display will be described before describing specific configuration examples of the scattering region 31.

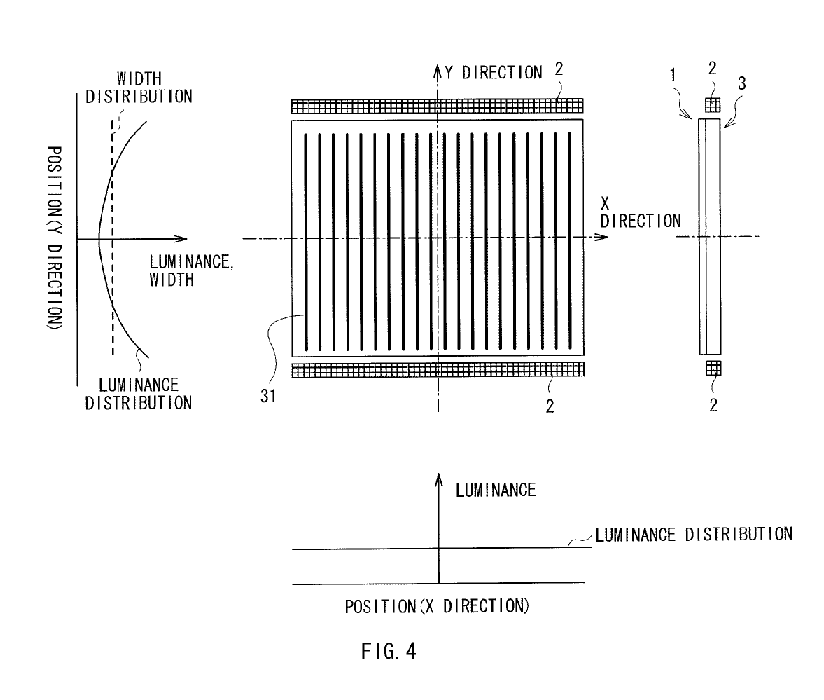

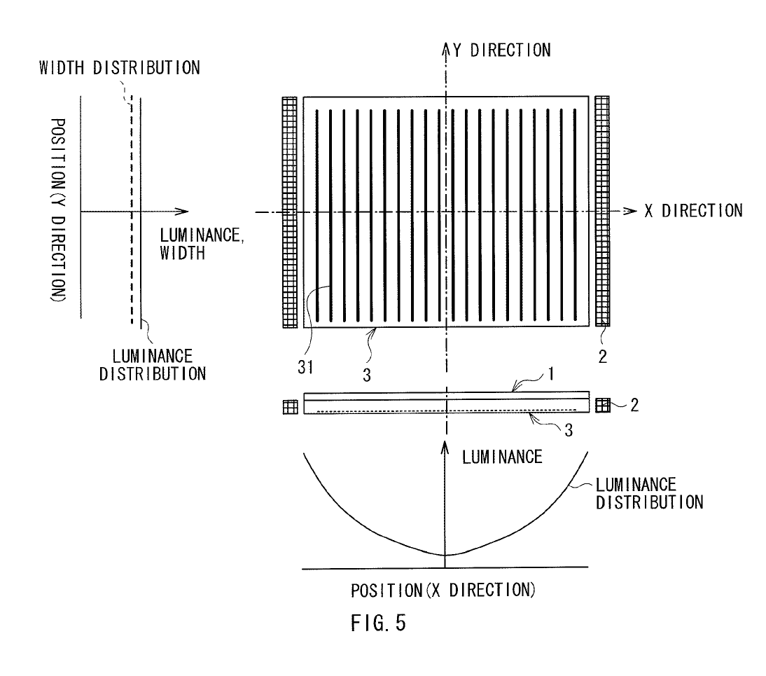

FIGS. 4 and 5 illustrate configurations of light source devices in display units according to first and second comparative examples and luminance distributions. In FIGS. 4 and 5, luminance distributions in the Y direction and in the X direction in the case where only the first light source 2 is maintained in the ON (turned-on) state are illustrated. FIG. 4 illustrates a plan view and a side view from the X direction of the light source device according to the first comparative example together with the luminance distributions. FIG. 4 further illustrates a width distribution in the Y direction of the scattering region 31. FIG. 4 illustrates luminance distributions in the case where the first light sources 2 are disposed on a first side surface and a second side surface facing each other in the Y direction. Moreover, a plurality of scattering regions 31 extend in the Y direction between the first side surface and the second surface, and are arranged side by side in the X direction. In the first comparative example, the entire width in the X direction of the scattering region 31 is uniform. In the case where the first light sources 2 are disposed in the Y direction, and the entire width distribution of the scattering region 31 is uniform, in the luminance distribution in the Y direction of light exiting from the light guide plate 3, there is a tendency that luminance is higher at a shorter distance from a predetermined side surface (the first side surface and the second side surface) where the first light source 2 is disposed and is lower at a longer distance from the predetermined side surface. In an example in FIG. 4, as the first light sources 2 are disposed on two predetermined side surfaces in the Y direction, luminance is higher at shorter distances from the two predetermined side surfaces in the Y direction, and is lowest in a central portion in the Y direction between the two predetermined side surfaces. On the other hand, the luminance distribution in the X direction is uniform irrespective of position.

FIG. 5 illustrates a plan view and a side view from the Y direction of the light source device according to the second comparative example together with the luminance distributions. FIG. 5 further illustrates a width distribution in the Y direction of the scattering region 31. FIG. 5 illustrates luminance distributions in the case where the first light sources 2 are disposed on a third side surface and a fourth side surface facing each other in the X direction. In the second comparative example, the entire width in the X direction of the scattering region 31 is uniform. In the case where the first light sources 2 are disposed in the X direction, and the entire width distribution of the scattering region 31 is uniform, in the luminance distribution in the X direction of light exiting from the light guide plate 3, there is a tendency that luminance is higher at a shorter distance from a predetermined side surface (the third side surface and the fourth side surface) where the first light source 2 is disposed and is lower at a longer distance from the predetermined side surface. In an example in FIG. 5, as the first light sources 2 are disposed on two predetermined side surfaces in the X direction, luminance is higher at shorter distances from the two predetermined side surfaces in the X direction, and is lowest in a central portion in the X direction between the two predetermined side surfaces. On the other hand, the luminance distribution in the Y direction is uniform irrespective of position.

As illustrated in FIGS. 4 and 5, luminance declines in part in the luminance distribution according to the position of the first light source 2 and the width of the scattering region 31 to cause nonuniform luminance. Ideally, it is preferable to have a uniform luminance distribution in both the X direction and the Y direction irrespective of position.

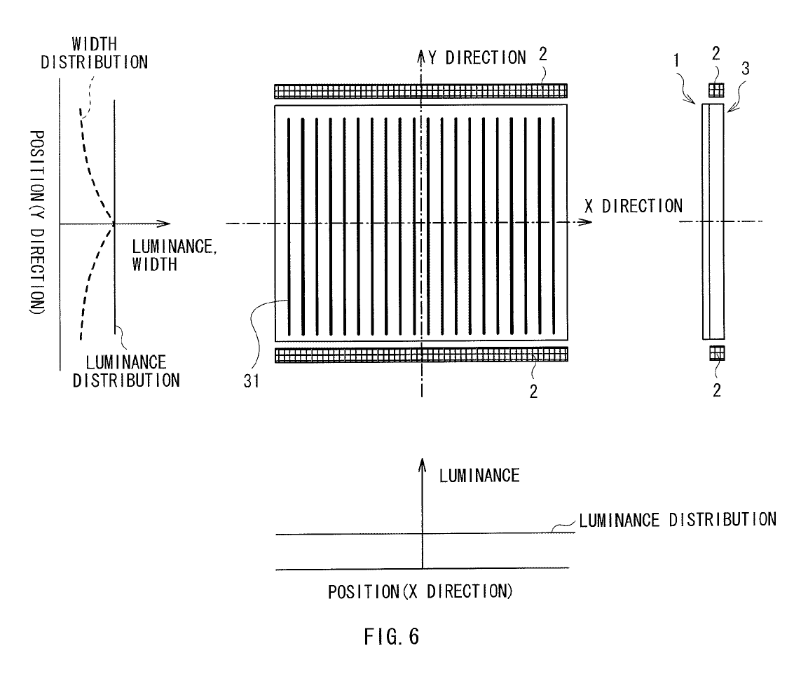

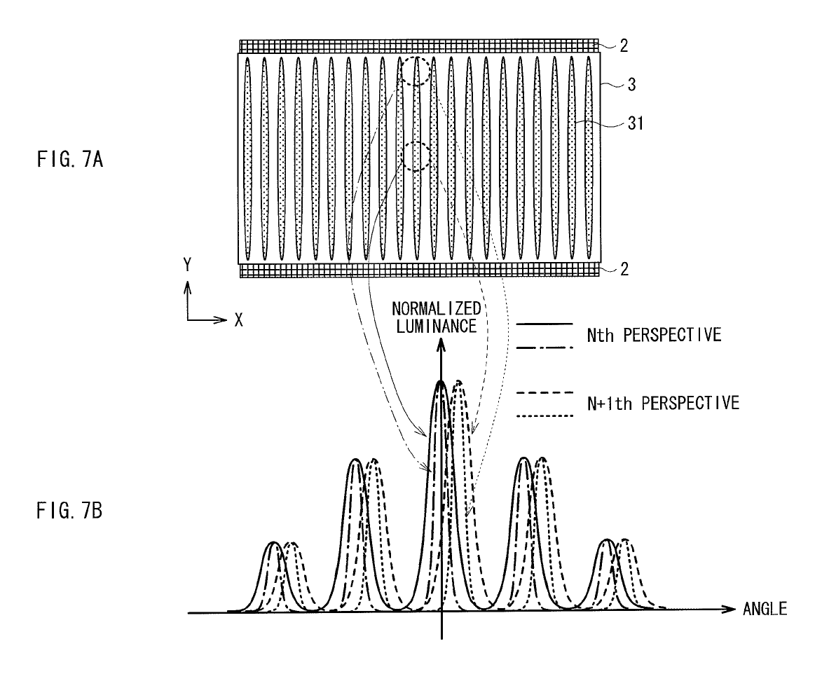

Therefore, like a display unit according to a third comparative example illustrated in FIG. 6 and a part (A) in FIG. 7, a configuration in which the width of the scattering region 31 varies according to a distance from the predetermined side surface where the first light source 2 is disposed to be smaller at a shorter distance from the predetermined side surface of the light guide plate 3 is considered. However, in this case, as illustrated in a part (B) in FIG. 7, a difference in width causes a difference in light-distribution characteristics of respective perspectives in three-dimensional display between a position close to the first light source 2 and a position around a screen center, thereby causing a difference in visibility of an image for three-dimensional display. It is to be noted that the part (B) in FIG. 7 illustrates light-distribution characteristics when a white image is displayed for one arbitrary perspective only and a black image is displayed for other perspectives in three-dimensional display, where N is an integer of 1 or more. When the width of the scattering region 31 varies according to a distance from the first light source 2, a maximum value of luminance is made uniform irrespective of position on a screen; however, entire light-distribution characteristics vary depending on position.

[Configuration Example of Scattering Region 31 with Improved Luminance Distribution]

### (Basic Configuration)

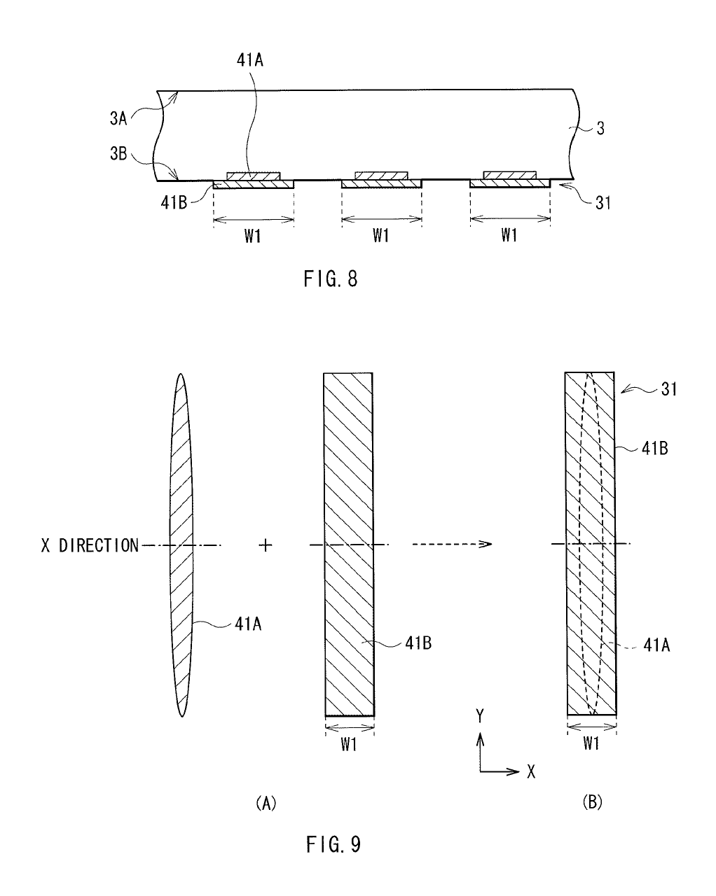

FIGS. 8 and 9 illustrate a basic configuration example of the scattering region 31 in which the above-described nonuniform luminance distribution and the above-described nonuniform light-distribution characteristics are corrected. It is to be noted that, as in the case of the comparative example in the part (A) in FIG. 7, FIGS. 8 and 9 illustrate a configuration example in which the first light sources 2 are disposed in the Y direction; however, even in the case where the first light sources 2 are disposed in the X direction, the luminance distribution is improved by a similar technique.

As illustrated in FIG. 8, the scattering regions 31 each are configured of a first scattering pattern 41A and a second scattering pattern 41B. As illustrated in a part (A) in FIG. 9, the first scattering pattern 41A has a configuration in which its width varies according to a distance from the first light source 2. In particular, the first scattering pattern 41A has a configuration in which its width is smaller at a shorter distance from the first light source 2. In this case, the first light sources 2 are disposed in the Y direction as an example; therefore, the width is smallest at both ends in the Y direction and increases toward a central portion.

The second scattering pattern 41B has a uniform width W1 irrespective of position. As illustrated in FIG. 8 and a part (B) in FIG. 9, the second scattering pattern 41B is disposed to cover the first scattering pattern 41A. As will be described later, for example, the first scattering pattern 41A is formed through roughening a surface of the light guide plate 3. The second scattering pattern 41B is formed through applying white ink to cover the first scattering pattern 41A.

The width W1 of the second scattering pattern 41B is a design value determined by specifications of three-dimensional display including a pixel configuration of the display section 1 and the number of perspectives. Three-dimensional display is achievable only through providing the second scattering pattern 41B; however, in this case, the luminance distribution becomes nonuniform depending on the distance from the first light source 2. Therefore, the nonuniform luminance distribution is adjusted through varying the width of the first scattering pattern 41A.

### First Specific Configuration Example

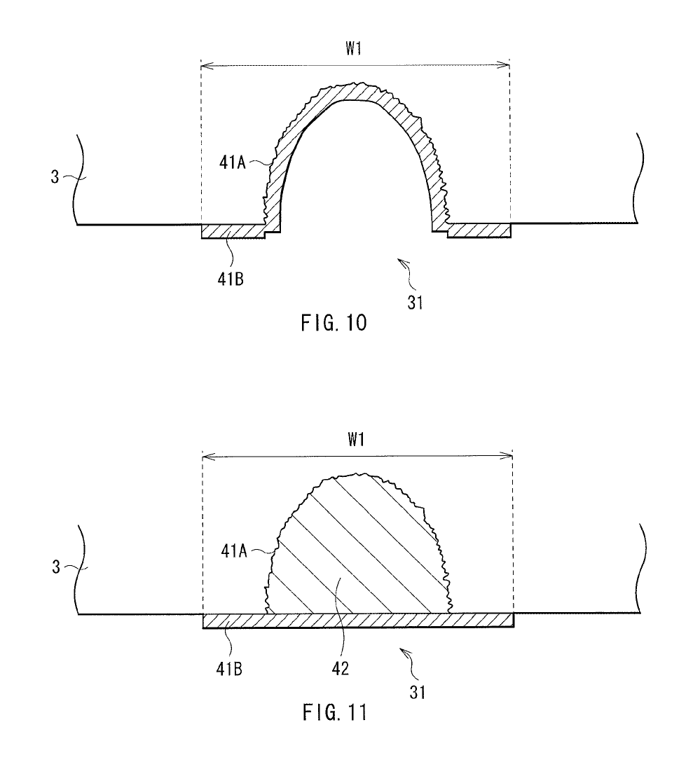

FIG. 10 illustrates a first specific configuration example corresponding to the basic configuration in FIGS. 8 and 9. In the first configuration example, the entire first scattering pattern 41A is formed through processing the surface of the light guide plate 3 into a sterically recessed pattern. Moreover, a surface of the sterically recessed pattern is roughened or provided with fine asperities by sandblast processing, laser processing, or the like. The second scattering pattern 41B is disposed to cover the surface of the sterically recessed pattern. The second scattering pattern 41B is formed through printing, for example, white ink which scatters light. It is to be noted that the first scattering pattern 41A may be processed into a sterically projected pattern instead of the recessed pattern.

### Second Specific Configuration Example

FIG. 11 illustrates a second specific configuration example. In the second configuration example, as in the case of the first configuration example in FIG. 10, the entire first scattering pattern 41A is formed through processing the surface of the light guide plate 3 into a sterically recessed pattern, and then roughening its surface. Moreover, a light-scattering material 42 such as a resin is filled in the sterically recessed pattern. The second scattering pattern 41B is formed through applying, for example, white ink to cover a portion where the light-scattering material 42 is filled.

### Third Specific Configuration Example

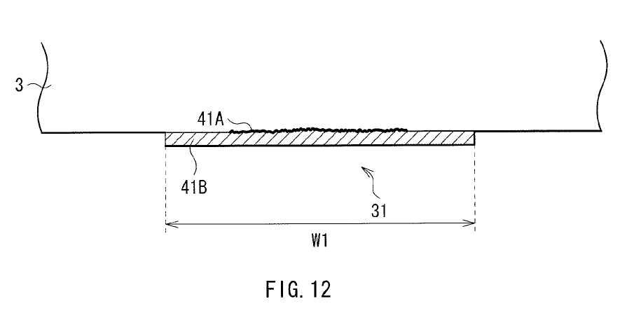

FIG. 12 illustrates a third specific configuration example. In the third configuration example, the first scattering pattern 41A has a planar pattern as a whole. The first scattering pattern 41A is formed through merely processing the surface of the light guide plate 3 by sandblast processing, laser processing or the like into a roughened surface or a surface provided with fine asperities. The second scattering pattern 41B is formed through applying, for example, white ink to cover such a planar pattern.

### (Modifications)

It is to be noted that, in the above-described respective configuration examples, an example in which the scattering region 31 is configured of two scattering patterns (two layers) is described; however, the scattering region 31 may be configured of three or more scattering patterns (three or more layers). Moreover, in the above-described respective configuration examples, the second scattering pattern 41B is formed of white ink; however, the second scattering pattern 41B may be formed of a metal film.

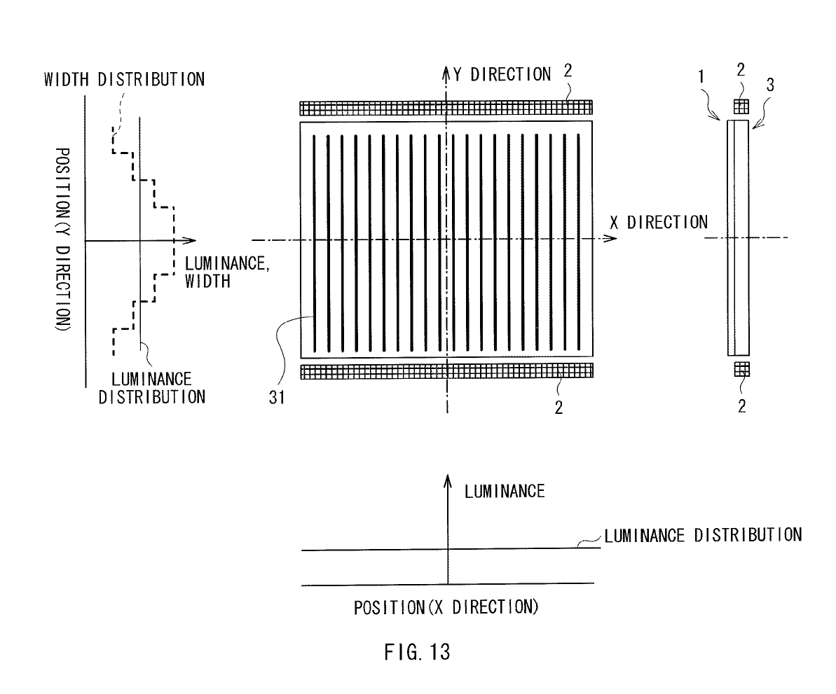

Further, as illustrated in FIG. 13, the width of the first scattering pattern 41A may vary in a stepwise manner.

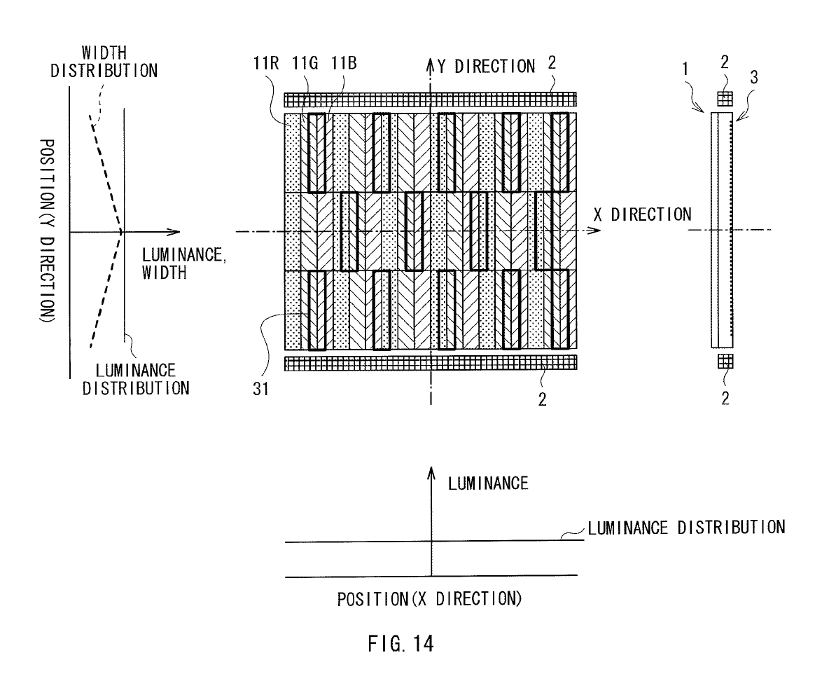

Moreover, the pattern of the scattering region 31 is not limited to a stripe-shaped pattern, and may be any other shaped pattern. For example, as illustrated in FIG. 14, the scattering regions 31 may be discretely distributed. In FIG. 14, an assignment pattern of perspective images in the display section 1 has a configuration in which a red pixel 11R, a green pixel 11G, and a blue pixel 11B are combined in a triangular shape. The scattering region 31 is disposed in a portion corresponding to an apex of the triangular shape corresponding to the assignment pattern of the perspective images. Therefore, the scattering regions 31 are discretely disposed in the X direction and in the Y direction. FIG. 14 illustrates an example in which the luminance distribution is improved in such an arrangement pattern of the scattering regions 31 through allowing the width of the first scattering pattern 41A to continuously decrease with decreasing distance from the two predetermined side surfaces in the Y direction in the light guide plate 3 and to continuously increase toward a center between the two predetermined side surfaces.

### [Effects]

As described above, in the display unit according to the present embodiment, the scattering regions 31 and the total reflection region 32 are disposed on the second internal reflection plane 3B of the light guide plate 3, and the light guide plate 3 allows the first illumination light from the first light source 2 and the second illumination light L10 from the second light source 7 to selectively exit therefrom; therefore, the light guide plate 3 equivalently functions as a parallax barrier. Thus, compared to the parallax barrier system stereoscopic display unit in related art, the number of components is reduced, and space saving is achievable.

Moreover, in the display unit according to the present embodiment, the scattering regions 31 each are configured of a plurality of scattering patterns, and each include the first scattering pattern 41A with a width varying according to the distance from the first light source 2 and the second scattering pattern 41B with a uniform width; therefore, illumination light with a desired luminance distribution is obtained. In particular, the luminance distribution in three-dimensional display is improved to achieve a uniform in-plane luminance distribution.

### 2. Second Embodiment

Next, a display unit according to a second embodiment of the disclosure will be described below. It is to be noted that like components are denoted by like numerals as of the display unit according to the first embodiment and will not be further described.

In the embodiment, modifications of the configuration of the scattering region 31 in the display unit according to the first embodiment will be described below.

### (Basic Configuration)

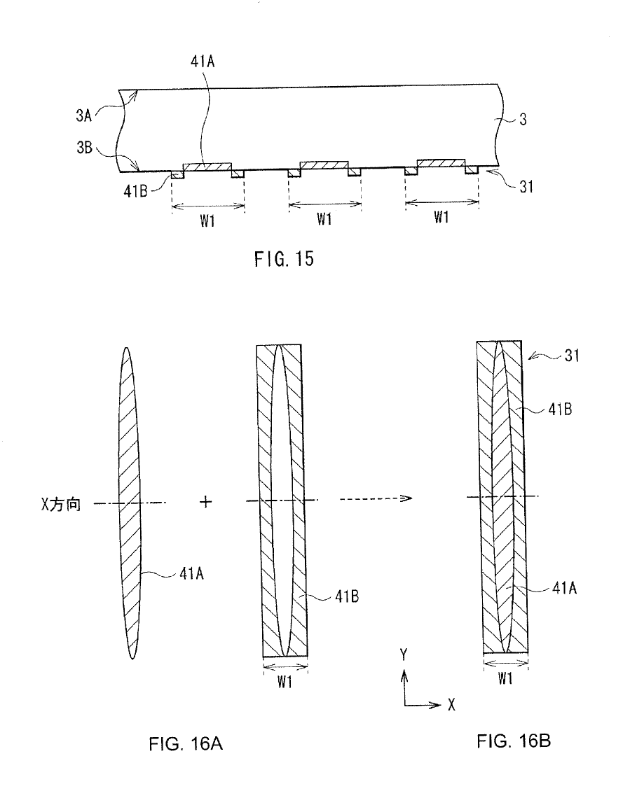

FIGS. 15 and 16A-B illustrate a basic configuration example of the scattering region 31 in the present embodiment. It is to be noted that, as in the case of the comparative example in the part (A) in FIG. 7, FIGS. 15 and 16A-B illustrate a configuration example in which the first light sources 2 are disposed in the Y direction; however, even in the case where the first light sources 2 are disposed in the X direction, the luminance distribution is improvable by a similar technique.

As illustrated in FIG. 15, the scattering regions 31 each are configured of the first scattering pattern 41A and the second scattering pattern 41B. As illustrated in FIG. 16A, the first scattering pattern 41A has a configuration in which its width varies according to the distance from the first light source 2. In particular, the first scattering pattern 41A has a configuration in which its width is smaller at a shorter distance from the first light source 2. In this case, the first light sources 2 are disposed in the Y direction as an example; therefore, the width is smallest at both ends in the Y direction and increases toward a central portion.

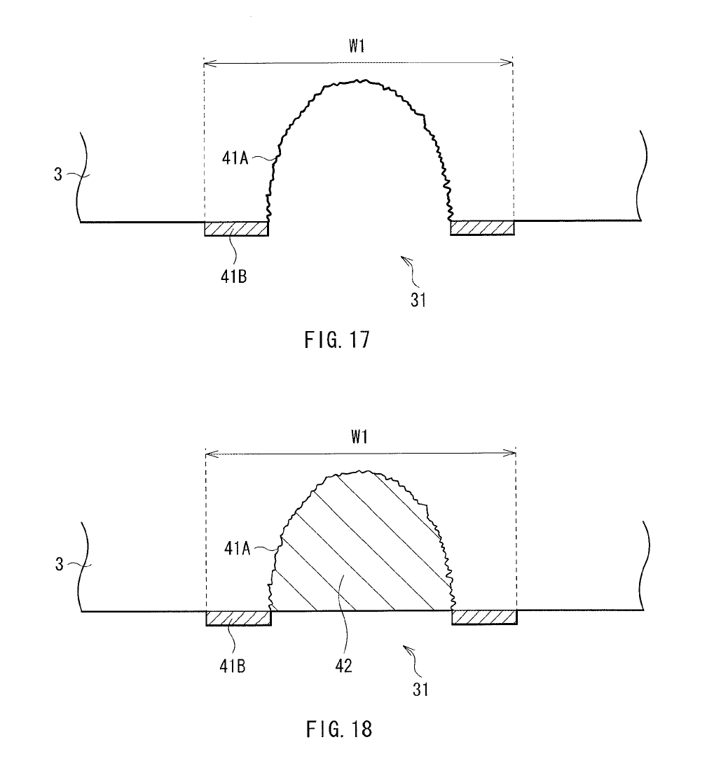

As illustrated in FIG. 15 and FIG. 16B, the second scattering patterns 41B are disposed on both sides, in a width direction, of the first scattering pattern 41A not to cover the first scattering pattern 41A. A width W1 of an integrated whole that is composed of the first scattering pattern 41A and the second scattering patterns 41B is uniform. It is to be noted that the second scattering pattern 41B may overlap the first scattering pattern 41A. Likewise, the second scattering pattern 41B may overlap the first scattering pattern 41A in configuration examples in FIGS. 17 to 19 which will be described later. Moreover, as in the case of the first embodiment, the second scattering pattern 41B may be formed of, for example, white ink or a metal film.

The width W1 of the integrated whole that is composed of the first scattering pattern 41A and the second scattering patterns 41B is a design value determined by specifications of three-dimensional display including the pixel configuration of the display section 1 and the number of perspectives.

### First Specific Configuration Example

FIG. 17 illustrates a first specific configuration example corresponding to the basic configuration in FIGS. 15 and 16A-B. In the first configuration example, the entire first scattering pattern 41A is formed through processing the surface of the light guide plate 3 into a sterically recessed pattern. Moreover, a surface of the sterically recessed pattern is roughened or provided with fine asperities by sandblast processing, laser processing, or the like. The second scattering patterns 41B are disposed on both sides, in the width direction, of the first scattering pattern 41A not to cover such a sterically recessed pattern. The second scattering pattern 41B is formed through printing, for example, white ink which scatters light. It is to be noted that the first scattering pattern 41A may be processed into a sterically projected pattern instead of the recessed pattern.

### Second Specific Configuration Example

FIG. 18 illustrates a second specific configuration example. In the second configuration example, as in the case of the first configuration example in FIGS. 16A-B, the entire first scattering pattern 41A is formed through processing the surface of the light guide plate 3 into a sterically recessed pattern, and then roughening its surface. Moreover, the light-scattering material 42 such as a resin is filled in the sterically recessed pattern. The second scattering patterns 41B are disposed on both sides, in the width direction, of the first scattering pattern 41A not to cover a portion where the light-scattering material 42 is filled, and is formed of, for example, white ink.

### Third Specific Configuration Example

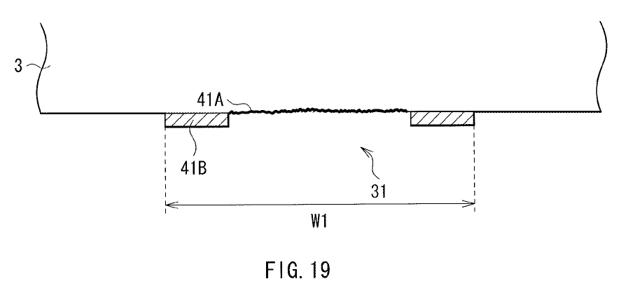

FIG. 19 illustrates a third specific configuration example. In the third configuration example, the first scattering pattern 41A has a planar pattern as a whole. The first scattering pattern 41A is formed through merely processing the surface of the light guide plate 3 by sandblast processing, laser processing or the like into a roughened surface or a surface provided with fine asperities. The second scattering patterns 41B are disposed on both sides, in the width direction, of the first scattering pattern 41A not to cover such a planar pattern, and is formed of, for example, white ink.

In the display unit according to the present embodiment, the scattering regions 31 each are configured of a plurality of scattering patterns, and each include the first scattering pattern 41A with a width varying according to the distance from the first light source 2 and the second scattering pattern 41B, and the integrated whole that is composed of the first scattering pattern 41A and the second scattering patterns 41B has a uniform width; therefore, illumination light with a desired luminance distribution is obtained. In particular, the luminance distribution in three-dimensional display is improved to achieve a uniform in-plane luminance distribution.

### 3. Third Embodiment

Next, a display unit according to a third embodiment of the disclosure will be described below. It is to be noted that like components are denoted by like numerals as of the display unit according to the first or second embodiment and will not be further described.

### [Entire Configuration of Display Unit]

In the first embodiment, a configuration example in which the scattering regions 31 and the total reflection regions 32 are disposed on the second internal reflection plane 3B in the light guide plate 3 is described; however, the scattering regions 31 and the total reflection regions 32 may be disposed on the first internal reflection plane 3A.

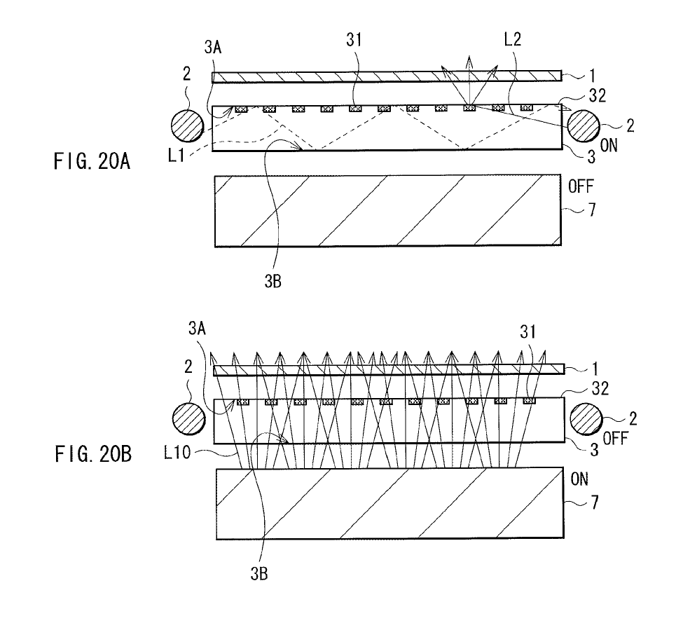

FIGS. 20A and 20B illustrate a configuration example of the display unit according to the third embodiment of the disclosure. As in the case of the display unit in FIG. 1, the display unit is capable of selectively and arbitrarily performing switching between the two-dimensional display mode and the three-dimensional display mode. FIG. 20A corresponds to a configuration in the three-dimensional display mode, and FIG. 20B corresponds to a configuration in the two-dimensional display mode. In FIGS. 20A and 20B, states of emission of light rays from the light source device in respective display modes are schematically illustrated.

The entire second internal reflection plane 3B is mirror-finished, and allows the first illumination light L1 incident at the incident angle θ1 satisfying the total-reflection condition to be reflected in a manner of total-internal-reflection. The first internal reflection plane 3A has the scattering regions 31 and the total reflection region 32. As in the case of the first or second embodiment, on the first internal reflection plane 3A, the total reflection region 32 and the scattering regions 31 are arranged in a pattern forming a configuration corresponding to a parallax barrier. In other words, in the three-dimensional display mode, the scattering regions 31 and the total-reflection region 32 function as opening sections (slit sections) and a shielding section, respectively, of a parallax barrier.

The total-reflection region 32 reflects the first illumination light L1 incident at the incident angle θ1 satisfying the total-reflection condition in a manner of total-internal-reflection (reflects the first illumination light L1 incident at the incident angle θ1 larger than a predetermined critical angle α in a manner of total-internal-reflection). The scattering regions 31 allow some or all of light rays, which are incident at an angle corresponding to the incident angle θ1 satisfying a predetermined total-reflection condition in the total reflection region 32, of incident light rays L2 to exit from the light guide plate 3 (the scattering regions 31 allow some or all of light rays incident at an angle corresponding to the incident angle θ1 larger than the predetermined critical angle α to exit from the light guide plate 3). The scattering regions 31 internally reflect some other light rays of the incident light rays L2.

In the display unit illustrated in FIGS. 20A and 20B, to spatially separate a plurality of perspective images displayed on the display section 1, it is necessary to dispose a pixel section of the display section 1 and the scattering regions 31 to face each other with a predetermined distance in between. In FIGS. 20A and 20B, the display section 1 and the light guide plate 3 are disposed with air in between; however, to keep the predetermined distance between the display section 1 and the light guide plate 3, a spacer may be disposed between the display section 1 and the light guide plate 3.

### [Basic Operation of Display Unit]

In the case where this display unit performs display in the three-dimensional display mode (refer to FIG. 20A), the display section 1 displays an image based on the three-dimensional image data, and the entire second light source 7 is controlled to be in the OFF (turned-off) state. The first light source 2 disposed on a side surface of the light guide plate 3 is controlled to be in the ON (turned-on) state. In this state, the first illumination light L1 from the first light source 2 is reflected repeatedly in a manner of total-internal-reflection between the total reflection region 32 of the first internal reflection plane 3A and the second internal reflection plane 3B in the light guide plate 3 to be guided from a side surface where the first light source 2 is disposed to the other side surface facing the side surface and then to be emitted from the other side surface. On the other hand, some light rays out of the total-reflection condition of the light rays L2 incident to the scattering regions 31 of the first internal reflection plane 3A of the light guide plate 3 exit from the light guide plane 3 through the scattering regions 31. In the scattering regions 31, some other light rays are internally reflected; however, the light rays exit from the light guide plate 3 through the second internal reflection plane 3B of the light guide plate 3, thereby not contributing to displaying an image. As a result, light rays are emitted only from the scattering regions 31 of the internal reflection plate 3A of the light guide plate 3. In other words, a surface of the light guide plate 3 equivalently functions as a parallax barrier with the scattering regions 31 as opening sections (slit sections) and the total reflection region 32 as a shielding section. Therefore, three-dimensional display by a parallax barrier system in which the parallax barrier is disposed on the back side of the display section 1 is equivalently performed.

On the other hand, in the case where display is performed in the two-dimensional display mode (refer to FIG. 20B), the display section 1 displays an image based on the two-dimensional image data, and the entire second light source 7 is controlled to be in the ON (turned-on) state. For example, the first light source 2 disposed on the side surface of the light guide plate 3 is not turned on. In this state, the second illumination light L10 from the second light source 7 enters the light guide plate 3 at an angle substantially perpendicular to the light guide plate 3 through the second internal reflection plane 3B. Therefore, the incident angle of the light rays is out of the total-reflection condition in the total reflection region 32; therefore, the light rays exit not only from the scattering regions 31 but also from the total reflection region 32. As a result, light rays are emitted from the entire first internal reflection plane 3A in the light guide plate 3. In other words, the light guide plate 3 functions as a planar light source similar to a typical backlight. Therefore, two-dimensional display by a backlight system in which a typical backlight is disposed on the back side of the display section 1 is equivalently performed.

It is to be noted that, when display is performed in the two-dimensional display mode, the first light source 2 disposed on the side surface of the light guide plate 3 may be also controlled to be in the ON (turned-on) state together with the second light source 7. Moreover, in the case where display is performed in the two-dimensional display mode, the first light source 2 may be switched between the turned-off state and the turned-on state as necessary. Therefore, for example, in the case where there is a difference in a luminance distribution between the scattering regions 31 and the total-reflection region 32 when only the second light source 7 is turned on, the lighting state of the first light source 2 is appropriately adjusted (ON/OFF control or the lighting amount of the first light source 2 is adjusted) to allow an entire luminance distribution to be optimized.

### [Effects]

As described above, in the display unit according to the present embodiment, the scattering regions 31 and the total reflection region 32 are disposed on the first internal reflection plane 3A of the light guide plate 3, and the first illumination light from the first light source 2 and the second illumination light L10 from the second light source 7 selectively exit from the light guide plate 3; therefore, the light guide plate 3 equivalently functions as a parallax barrier. Thus, compared to the parallax barrier system stereoscopic display unit in related art, the number of components is reduced, and space saving is achievable.

Moreover, in this embodiment, when the configuration of the scattering region 31 is similar to that in the first or second embodiment, the luminance distribution in three-dimensional display is improved.

### 4. Fourth Embodiment

Next, a display unit according to a fourth embodiment of the disclosure will be described below. It is to be noted that like components are denoted by like numerals as of the display units according to the first to third embodiments and will not be further described.

### [Entire Configuration of Display Unit]

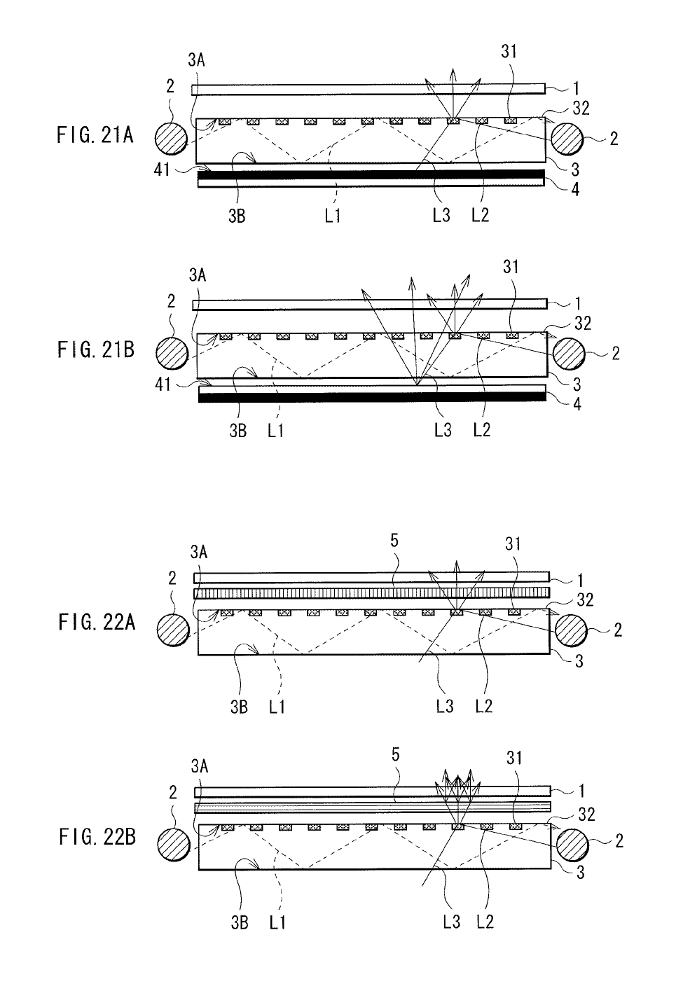

FIGS. 21A and 21B illustrate a configuration example of the display unit according to the fourth embodiment of the disclosure. The display unit includes an electronic paper 4 instead of the second light source 7 in the display unit illustrated in FIGS. 20A and 20B.

The display unit is capable of selectively and arbitrarily performing switching between the two-dimensional display mode on an entire screen and the three-dimensional display mode on the entire screen. FIG. 21A corresponds to a configuration in the three-dimensional display mode, and FIG. 21B corresponds to a configuration in the two-dimensional display mode. In FIGS. 21A and 21B, states of emission of light rays from the light source device in respective display modes are schematically illustrated.

The electronic paper 4 is disposed to face a side (a side where the second internal reflection plane 3B is formed) of the light guide plate 3. The side is opposite to a direction where the first illumination light L1 exits. The electronic paper 4 is an optical device allowed to be selectively switched, in a mode of action on incident light rays, between two modes, i.e., a light absorption mode and a scattering-reflection mode. The electronic paper 4 is configured of, for example, a particle migration type display device by an electrophoresis system or an electronic liquid powder system. In the particle migration type display device, for example, positively-charged black particles and negatively-charged white particles are dispersed between a pair of substrates facing each other, and the particles are migrated according to a voltage applied between the substrates to perform display in a black state or a white state. In particular, in the electrophoresis system, the particles are dispersed in a solution, and in the electronic liquid powder system, the particles are dispersed in a gas. The above-described light absorption mode corresponds to the case where an entire display plane 41 of the electronic paper 4 is maintained in a black state of display as illustrated in FIG. 21A, and the scattering-reflection mode corresponds to the case where the entire display plane 41 of the electronic paper 4 is maintained in a white state of display as illustrated in FIG. 21B. In the case where the display section 1 displays a plurality of perspective images based on three-dimensional image data (in the case of the three-dimensional display mode), in the electronic paper 4, the mode of action on incident light rays is maintained in the light absorption mode. In the case where the display section 1 displays an image based on two-dimensional image data (in the case of two-dimensional display mode), in the electronic paper 4, the mode of action on incident light rays is maintained in the scattering-reflection mode.

In the display unit illustrated in FIGS. 21A and 21B, to spatially separate a plurality of perspective images displayed on the display section 1, it is necessary to dispose a pixel section of the display section 1 and the scattering regions 31 of the light guide plate 3 with a predetermined distance in between. In FIGS. 21A and 21B, the display section 1 and the light guide plate 3 are disposed with air in between; however, to keep the predetermined distance between the display section 1 and the light guide plate 3, a spacer may be disposed between the display section 1 and the light guide plate 3.

### [Operation of Display Unit]

In the display unit, in the case where display is performed in the three-dimensional display mode (refer to FIG. 21A), the display section 1 displays an image based on the three-dimensional image data, and the entire display plane 41 of the electronic paper 4 is maintained in the black state of display (the light absorption mode). In this state, the first illumination light L1 from the first light source 2 is reflected repeatedly in a manner of total-internal-reflection between the total reflection region 32 of the first internal reflection plane 3A and the second internal reflection plane 3B in the light guide plate 3 to be guided from a side surface where the first light source 2 is disposed to the other side surface facing the side surface and then to be emitted from the other side surface. On the other hand, some light rays out of the total-reflection condition of the light rays L2 incident to the scattering regions 31 of the first internal reflection plane 3A of the light guide plate 3 exit from the light guide plate 3 through the scattering regions 31. The scattering regions 31 internally reflect some other light rays L3, and the light rays L3 enter the display plane 41 of the electronic paper 4 through the second internal reflection plane 3B of the light guide plate 3. In this case, the entire display plane 41 of the electronic paper 4 is maintained in the black state of display; therefore, the light rays L3 are absorbed by the display plane 41. As a result, in the light guide plate 3, light rays are emitted from only the scattering regions 31 of the first internal reflection plane 3A. In other words, a surface of the light guide plate 3 equivalently functions as a parallax barrier with the scattering regions 31 as opening sections (slit sections) and the total reflection region 32 as a shielding section. Therefore, three-dimensional display by a parallax barrier system in which the parallax barrier is disposed on the back side of the display section 1 is equivalently performed.

On the other hand, in the case where display is performed in the two-dimensional display mode (refer to FIG. 21B), the display section 1 displays an image based on the two-dimensional image data, and the entire display plane 41 of the electronic paper 4 is maintained in the white state of display (the scattering-reflection mode). In this state, the first illumination light L1 from the first light source 2 is reflected repeatedly in a manner of total-internal-reflection between the total reflection region 32 of the first internal reflection plane 3A and the second internal reflection plane 3B in the light guide plate 3 to be guided from a side surface where the first light source 2 is disposed to the other side surface facing the side surface and then to be emitted from the other side surface. On the other hand, some light rays out of the total-reflection condition of the light rays L2 incident to the scattering regions 31 of the first internal reflection plane 3A in the light guide plate 3 exit from the light guide plate 3 through the scattering regions 31. The scattering regions 31 internally reflect some other light rays L3, and the light rays L3 enter the display plane 41 of the electronic paper 4 through the second internal reflection plane 3B of the light guide plate 3. In this case, the entire display plane 41 of the electronic paper 4 is maintained in the white state of display; therefore, the light rays L3 are scattered and reflected by the display plane 41. The light rays scattered and reflected by the display plane 41 enter the light guide plate 3 again through the second internal reflection plane 3B; however, the incident angle of the light rays is out of the total-reflection condition in the total reflection region 32, and the light rays exit not only from the scattering regions 31 but also from the total reflection region 32. As a result, light rays are emitted from the entire first internal reflection plane 3A in the light guide plate 3. In other words, the light guide plate 3 functions as a planar light source similar to a typical backlight. Therefore, two-dimensional display by a backlight system in which a typical backlight is disposed on the back side of the display section 1 is equivalently performed.

### [Effects]

As described above, in the display unit according to the present embodiment, the scattering regions 31 and the total reflection region 32 are disposed on the first internal reflection plane 3A of the light guide plate 3; therefore, the light guide plate 3 equivalently functions as a parallax barrier. Thus, compared to the parallax barrier system stereoscopic display unit in related art, the number of components is reduced, and space saving is achievable. Moreover, switching between the two-dimensional display mode and the three-dimensional display mode is easily performed through only switching the display state of the electronic paper 4.

Moreover, in this embodiment, when the configuration of the scattering region 31 is similar to that in the first or second embodiment, the luminance distribution in three-dimensional display is improved.

### 5. Fifth Embodiment

Next, a display unit according to a fifth embodiment of the disclosure will be described below. It is to be noted that like components are denoted by like numerals as of the display units according to the first to fourth embodiments and will not be further described.

### [Entire Configuration of Display Unit]

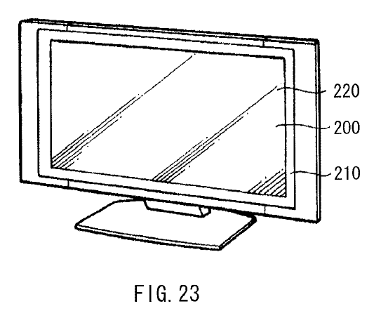

FIGS. 22A and 22B illustrate a configuration example of the display unit according to the fifth embodiment of the disclosure. As in the case of the display unit illustrated in FIGS. 21A and 21B, the display unit is capable of selectively and arbitrarily performing switching between the two-dimensional display mode and the three-dimensional display mode. FIG. 22A corresponds to a configuration in the three-dimensional display mode, and FIG. 22B corresponds to a configuration in the two-dimensional display mode. In FIGS. 22A and 22B, states of emission of light rays from the light source device in respective display modes are schematically illustrated.

In the display unit, the light source device includes a polymer diffuser plate 5 instead of the electronic paper 4 in the display unit illustrated in FIGS. 21A and 21B. The display unit has a configuration similar to that of the display unit in FIGS. 21A and 21B, except for the above-described configuration. The polymer diffuser plate 5 is configured with use of a polymer-dispersed liquid crystal. The polymer diffuser plate 5 is disposed to face the light guide plate 3 in a direction where the first illumination light L1 exits (a side where the first internal reflection plane 3A is formed). The polymer diffuser plate 5 is an optical device allowed to be selectively switched, in a mode of action on incident light rays, between two modes, i.e., a transparent mode and a scattering-transmission mode.

### [Basic Operation of Display Unit]

In the display unit, when display is performed in the three-dimensional display mode (refer to FIG. 22A), the display section 1 displays an image based on the three-dimensional image data, and the entire polymer diffuser plate 5 is maintained in the transparent mode. In this state, the first illumination light L1 from the first light source 2 is reflected repeatedly in a manner of total-internal-reflection between the total reflection region 32 of the first internal reflection plane 3A and the second internal reflection plane 3B in the light guide plate 3 to be guided from a side surface where the first light source 2 is disposed to the other side surface facing the side surface and then to be emitted from the other side surface. On the other hand, some light rays out of the total-reflection condition of the light rays L2 incident to the scattering regions 31 of the first internal reflection plane 3A of the light guide plate 3 exit from the light guide plate 3 through the scattering regions 31. The light rays exiting from the light guide plate 3 through the scattering regions 31 enter the polymer diffuser plate 5. However, as the entire polymer diffuser plate 5 is maintained in the transparent mode, the light rays pass through the polymer diffuser plate 5 while maintaining their emission angles from the scattering regions 31 to enter the display section 1. The scattering regions 31 internally reflect some other light rays L3; however, the light rays L3 exit from the light guide plate 3 through the second internal reflection plane 3B, thereby not contributing to displaying an image. As a result, light rays are emitted only from the scattering regions 31 of the first internal reflection plane 3A of the light guide plate 3. In other words, a surface of the light guide plate 3 equivalently functions as a parallax barrier with the scattering regions 31 as opening sections (slit sections) and the total reflection region 32 as a shielding section. Therefore, three-dimensional display by a parallax barrier system in which the parallax barrier is disposed on the back side of the display section 1 is equivalently performed.

On the other hand, in the case where display is performed in the two-dimensional display mode (refer to FIG. 22B), the display section 1 displays an image based on the two-dimensional image data, and the entire polymer diffuser plate 5 is maintained in the scattering-transmission mode. In this state, the first illumination light L1 from the first light source 2 is reflected repeatedly in a manner of total-internal-reflection between the total reflection region 32 of the first internal reflection plane 3A and the second internal reflection plane 3B in the light guide plate 3 to be guided from a side surface where the first light source 2 is disposed to the other side surface facing the side surface and then to be emitted from the other side surface. On the other hand, some light rays out of the total-reflection condition of the light rays L2 incident to the scattering regions 31 of the first internal reflection plane 3A in the light guide plate 3 exit from the light guide plate 3 through the scattering regions 31. In this case, light rays exiting from the light guide plate 3 through the scattering regions 31 enter the polymer diffuser plate 5. However, as the entire polymer diffuser plate 5 is maintained in the scattering-transmission mode, light rays incident to the display section 1 are scattered by the entire polymer diffuser plate 5. As a result, the light source device as a whole functions as a planar light source similar to a typical backlight. Therefore, two-dimensional display by a backlight system in which a typical backlight is disposed on the back side of the display section 1 is equivalently performed.

Moreover, in this embodiment, when the configuration of the scattering region 31 is similar to that in the first or second embodiment, the luminance distribution in three-dimensional display is improved.

### 6. Other Embodiments

Although the present disclosure is described referring to the above-described embodiments, the disclosure is not limited thereto, and may be variously modified. For example, the display units according to the above-described embodiments each are applicable to various electronic apparatuses having a display function. FIG. 23 illustrates an appearance configuration of a television as an example of such an electronic apparatus. The television includes an image display screen section 200 including a front panel 210 and a filter glass 220.

Moreover, for example, the disclosure may have the following configurations.

(1) A display unit including:

a display section displaying an image; and

a light source device emitting light for image display toward the display section, the light source device including a first light source emitting first illumination light and a light guide plate, the light guide plate including a plurality of scattering regions that allow the first illumination light entering through a side surface of the light guide plate to be scattered and then to exit from the light guide plate,

in which the scattering regions each are configured of a plurality of scattering patterns including a first scattering pattern with a width varying according to a distance from the first light source.

(2) The display unit according to (1), in which

the first scattering pattern has a width decreasing with decreasing distance from the first light source.

(3) The display unit according to (1) or (2), in which

the plurality of scattering patterns further include a second scattering pattern with a uniform width.

(4) The display unit according to (3), in which

the second scattering pattern is disposed to cover the first scattering pattern.

(5) The display unit according to (1) or (2), in which

the plurality of scattering patterns further include second scattering patterns disposed on both sides, in a width direction, of the first scattering pattern.

(6) The display unit according to (5), in which

an integrated whole that is composed of the first scattering pattern and the second scattering patterns has a uniform width.

(7) The display unit according to any one of (1) to (6), further including a second light source disposed to face the light guide plate, the second light source applying second illumination light toward the light guide plate from a direction different from a light-application direction of the first light source.

(8) The display unit according to (7), in which

the display section selectively switches images to be displayed between perspective images based on three-dimensional image data and an image based on two-dimensional image data, and

the second light source is controlled to be turned off when the perspective images are to be displayed on the display section, and is controlled to be turned on when the image based on the two-dimensional image data is to be displayed on the display section.

(9) The display unit according to (8), in which

the first light source is controlled to be turned on when the perspective images are to be displayed on the display section, and is controlled to be either turned off or turned on when the image based on the two-dimensional image data is to be displayed on the display section.

(10) The display unit according to any one of (1) to (6), further including an optical device disposed to face the light guide plate on a side opposite to an emission direction of the first illumination light, and allowed to be selectively switched, in a mode of action on incident light rays, between a light absorption mode and a scattering-reflection mode.

(11) The display unit according to any one of (1) to (6), further including an optical device disposed to face the light guide plate in an emission direction of the first illumination light, and allowed to be selectively switched, in a mode of action on incident light rays, between a transparent mode and a scattering-transmission mode.

(12) A light source device including:

a first light source emitting first illumination light; and

a light guide plate including a plurality of scattering regions that allow the first illumination light entering through a side surface of the light guide plate to be scattered and then to exit from the light guide plate,

in which the scattering regions each are configured of a plurality of scattering patterns including a first scattering pattern with a width varying according to a distance from the first light source.

(13) An electronic apparatus including a display unit, the display unit including:

a display section displaying an image; and

a light source device emitting light for image display toward the display section, the light source device including a first light source emitting first illumination light and a light guide plate, the light guide plate including a plurality of scattering regions that allow the first illumination light entering through a side surface of the light guide plate to be scattered and then to exit from the light guide plate,

in which the scattering regions each are configured of a plurality of scattering patterns including a first scattering pattern with a width varying according to a distance from the first light source.

The present application contains subject matter related to that disclosed in Japanese Priority Patent Application No. 2011-248474 filed in the Japan Patent Office on Nov. 14, 2011, the entire content of which is hereby incorporated by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. A display unit comprising:
a display section displaying an image; and
a light source device emitting light for image display toward the display section, the light source device including a first light source emitting first illumination light and a light guide plate, the light guide plate including a plurality of scattering regions that allow the first illumination light entering through a side surface of the light guide plate to be scattered and then to exit from the light guide plate,
wherein the scattering regions each are configured of a plurality of scattering patterns including a first scattering pattern with a width varying according to a distance from the first light source.

2. The display unit according to claim 1, wherein
the first scattering pattern has a width decreasing with decreasing distance from the first light source.

3. The display unit according to claim 1, wherein
the plurality of scattering patterns further include a second scattering pattern with a uniform width.

4. The display unit according to claim 3, wherein
the second scattering pattern is disposed to cover the first scattering pattern.

5. The display unit according to claim 1, wherein
the plurality of scattering patterns further include second scattering patterns disposed on both sides, in a width direction, of the first scattering pattern.

6. The display unit according to claim 5, wherein
an integrated whole that is composed of the first scattering pattern and the second scattering patterns has a uniform width.

7. The display unit according to claim 1, further comprising a second light source disposed to face the light guide plate, the second light source applying second illumination light toward the light guide plate from a direction different from a light-application direction of the first light source.

8. The display unit according to claim 7, wherein
the display section selectively switches images to be displayed between perspective images based on three-dimensional image data and an image based on two-dimensional image data, and
the second light source is controlled to be turned off when the perspective images are to be displayed on the display section, and is controlled to be turned on when the image based on the two-dimensional image data is to be displayed on the display section.

9. The display unit according to claim 8, wherein
the first light source is controlled to be turned on when the perspective images are to be displayed on the display section, and is controlled to be either turned off or turned on when the image based on the two-dimensional image data is to be displayed on the display section.

10. The display unit according to claim 1, further comprising an optical device disposed to face the light guide plate on a side opposite to an emission direction of the first illumination light, and allowed to be selectively switched, in a mode of action on incident light rays, between a light absorption mode and a scattering-reflection mode.

11. The display unit according to claim 1, further comprising an optical device disposed to face the light guide plate in an emission direction of the first illumination light, and allowed to be selectively switched, in a mode of action on incident light rays, between a transparent mode and a scattering-transmission mode.

12. A light source device comprising:
a first light source emitting first illumination light; and
a light guide plate including a plurality of scattering regions that allow the first illumination light entering through a side surface of the light guide plate to be scattered and then to exit from the light guide plate,
wherein the scattering regions each are configured of a plurality of scattering patterns including a first scattering pattern with a width varying according to a distance from the first light source.

13. An electronic apparatus including a display unit, the display unit comprising:
a display section displaying an image; and
a light source device emitting light for image display toward the display section, the light source device including a first light source emitting first illumination light and a light guide plate, the light guide plate including a plurality of scattering regions that allow the first illumination light entering through a side surface of the light guide plate to be scattered and then to exit from the light guide plate,
wherein the scattering regions each are configured of a plurality of scattering patterns including a first scattering pattern with a width varying according to a distance from the first light source.
